(19) United States
(12) Patent Application Publication
(10) Pub. No.: US 2023/0406398 A1
(43) Pub. Date: Dec. 21, 2023

(54) APPARATUS AND KIT FOR FORD VEHICLE STEERING RACK AND PINION

(71) Applicant: BroncBuster LLC, Fischer, TX (US)

(72) Inventor: Tyler Mason, Fischer, TX (US)

(21) Appl. No.: 18/089,350

(22) Filed: Dec. 27, 2022

Related U.S. Application Data
(60) Provisional application No. 63/294,065, filed on Dec. 27, 2021.

(51) Int. Cl. B62D 3/12

(52) U.S. Cl. CPC B62D 3/12

(57) ABSTRACT

A kit of parts for a rack and pinion steering system modification includes a bushing to be slid over an end of a rack rod and inserted into an opening of a rack housing of the rack and pinion steering assembly on the driver's side, a clip to be attached to the open end of the rack housing to ensure that the bushing remains in position inside the rack housing, and a hose clamp to be used to clamp a proximal end of a flexible rubber boot at an end of the rack and pinion steering assembly. The bushing may be made of acetal homopolyer.

### CROSS-REFERENCE TO RELATED APPLICATIONS

This application claims priority to U.S. Provisional Patent Application No. 63/294,065 filed on Dec. 27, 2021, entitled “Apparatus and Kit for Ford Vehicle Steering Rack and Pinion,” the contents of which are hereby incorporated herein by reference.

### BACKGROUND

### Field of the Art

This disclosure relates to vehicular steering rack and pinion systems. More specifically, a kit of parts includes a bushing and a keeper dip, where the bushing is to be inserted on the drivers side end of a steering rack housing, and the keeper clip ensures that the bushing is retained in place. The bushing is inserted into the steering rack housing for the purpose of reinforcing the plastic keeper already installed in the housing, to preclude the steering pinion from disengaging from the teeth of the rack rod for the 2021 Ford Bronco® and the 2022 Ford Bronco®, and these same parts could be applied to reinforce steering rack in the Gen 2, and 3 Ford Raptor®, and the 2021 and 2022 Ford Ranger®.

### Discussion of the State of the Art

Vehicles such as the 2021/2022. Ford Bronco® are often used in off-road scenarios. Many off-road users like to make modifications such as installing oversized tires and suspension lift. Such modifications may unintentionally interfere with systems of the original design of the vehicle.

One example relative to the present invention is that modifications to the suspension such as lift and wheels on such vehicles as the Bronco®, in combination with impacts from the rough terrain encountered during off-road operations, have been known to cause the original plastic keeper bushing in the rack housing of the steering rack and pinion system to degrade to the point that the steering pinion no longer meshes with the teeth of the steering rack rod, resulting in sometimes intermittent and, in other cases, a complete and catastrophic loss of steering for the vehicle.

The manufacturer considers that the vehicle has been properly designed and tested for its intended normal operation and that it does not assume responsibility when users modify the original systems designs. As such, there is a need for a solution to prevent loss of steering for these vehicles when the vehicles have been modified.

### SUMMARY

The inventor has recognized that the original rack and pinion bushings can degrade and even fail when modifications desired by off-roading enthusiasts, such as suspension lift and oversized tires, are incorporated in at least some models such as the (2021/2022) Ford Bronco®, Gen 2 or Gen 3 Ford Raptor®, and/or the (2021/2022) Ford Ranger®. The inventor has recognized that examples of loss of manual steering capability on these vehicles can be attributed to the added torques and impacts of off-roading, causing the original bushing in the rack and pinion steering assembly to degrade to the point that the pinion can disengage from the teeth of the steering rack, resulting in a complete lack of steering capability.

To overcome this problem, the invention provides a kit of parts that can be added to the factory configuration of a vehicle without replacing any existing substantive components. In an exemplary preferred embodiment, the kit includes one bushing (for the driver's side of the rack closest to the rack and pinion engagement point) sized to slide over the steering rack and fit snugly into the steering rack housing, a corresponding keeper clip designed to ensure that the bushing cannot vibrate out of the rack housing, and a clamp to replace the original clamp on the flexible rubber boot on the tie rods, since the manufacturer specifically describes the original clamp on the flexible rubber boot as “one time use only.”

The present invention thereby provides a bushing that is sized to reinforce the plastic bushing in the original steering rack assembly so that steering capability cannot be lost due to the steering pinion no longer engaging the teeth on the rack rod such as when a 2021/2022 Ford Bronco® or Ford Ranger® is modified with an aftermarket lift kit and/or oversized tires for off-roading. Thus, the kit provided by the present invention does not replace the original steering rack components.

Although the kit of the invention was designed specifically for the Bronco® and Ranger® vehicles, the concepts of the invention are easily modified as appropriate for other vehicle models, as should be readily apparent after reading this disclosure.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates schematically steering components of a conventional vehicle steering system 100 with manual steering.

FIG. 2 illustrates components of the kit of parts 200 provided by an exemplary embodiment of the present invention.

FIG. 3 illustrates in flowchart format the steps 300 for incorporating the kit components of the present invention.

### DETAILED DESCRIPTION

The inventor has recognized a problem that exists in steering systems of vehicles often used for off-roading, such as the Ford Bronco®. Owners of these vehicles often modify various systems on their vehicles to improve their off-road performance, including, for example, installing suspension lift and installing larger tires. Such modifications can eventually cause unintended problems or failures such as a degradation in the original steering rack bushing that permits the steering pinion to disengage from the teeth of the steering rack, resulting in complete loss of steering of the vehicle. The present invention provides a kit of parts that can be incorporated into the original factory steering with minimal effort and without replacing any of the original steering components except the original boot clamp on the flexible rubber boot on the driver side tie rod since the manufacturer explicitly specifies that this clamp is “single use only”.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, Where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Overview

The apparatus of the present invention comprises a kit of parts to act as additional reinforcement to the original bushings installed in the steering rack housing as original equipment from the factory. The kit provides a mechanism intended to preclude a breakdown of these original bushings and resultant loss of steering capability.

The components of this kit can be easily incorporated into the original steering system without replacing original parts except the clamp used on the flexible rubber boot on the tie rod on the driver's side, since the manufacturer specifically describes this clamp as a one-time-use clamp.

It is noted that the steering bushing of the present invention could possibly become standard steering system components should the location, material, or dimensions of this bushing demonstrate performance that is superior.

### Apparatus

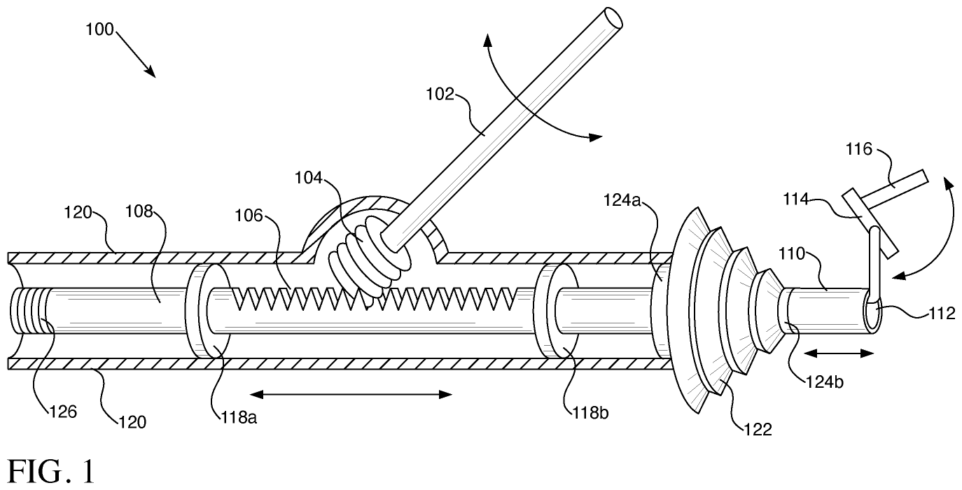

FIG. 1 illustrates, in schematic format, the components of a conventional vehicular steering system 100 using manual steering via a steering rack and pinion design. As demonstrated in FIG. 1, steering commands from the vehicle driver (not shown) are provided as input commands via the steering shaft 102 connected to the pinion 104 of the rack and pinion assembly 100. The teeth of the pinion 104 are meshed with the teeth 106 of the rack rod 108 such that a rotary action of the steering shaft 102 translates into a linear movement of the rack rod 108. The tie rod 110 connects the linear movements of the rack rod 108 to the steering ball socket 112, which, in turn, is connected to the steering knuckle 114 connected to the wheel spindle 116. The ball socket 112 and steering knuckle 114 cause the linear movements of the tie rod 110 to be translated into a rotary action of the wheel spindle 116, which provides the steering position of the front wheel (not shown) to rotate in accordance with the driver's steering wheel commands.

The plastic rack bushings 118a, 11.8b serve as bearings to support the rack 108 such that the pinion gear 104 and teeth 106 of the rack rod 108 are constantly meshed. The rack and pinion assembly is enclosed by the rack housing 120. The rack housing 120 is open on both ends, as depicted on the left side of FIG. 1.

Flexible rubber boot 122 keeps dirt and other contaminants out of the interior of the rack housing 120, and clamps 124a, 1.24h keep the flexible rubber boot 122 attached respectively to the rack housing 120 and tie rod 110. FIG. 1 shows the interconnection of components to the wheel spindle 116 on the right side of the figure. Similar interconnection components (not shown in FIG. 1) would be used to connect to the opposite wheel spindle. The left side of FIG. 1 demonstrates that the rack 108 is connected to the tie rod 110 using a screwed coupling 126.

The loss of steering control in vehicles with modifications such as suspension lift and larger wheels is due to the plastic bushings 118a, 118b being unable to withstand larger torques due to such modifications and impacts during off-road operations. When bushings 118a, 118b get damaged, the steering pinion 104 no longer remains meshed with the teeth 106 of the steering rack rod 108.

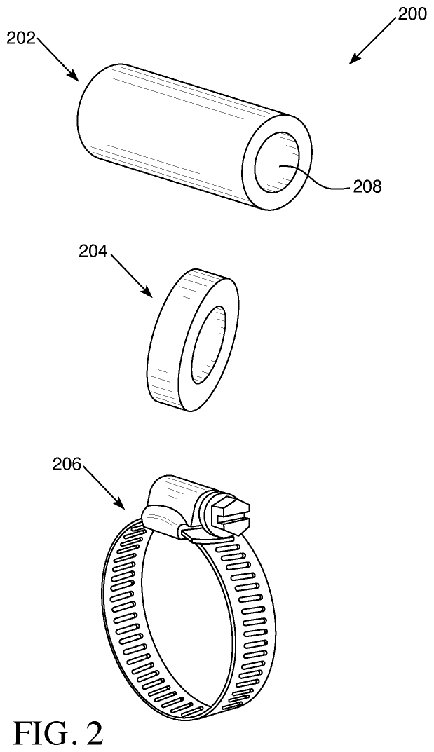

FIG. 2 shows the components of a kit 200 of parts (not drawn to scale) of an exemplary embodiment of the invention. A bushing 202 is provided in this kit 200, for the driver's side rack rod of the steering assembly. The kit 200 further includes a clip 204 that is a stamped/pressed aluminum piece that will be used to further ensure that the bushing 202 remains in position when installed in the steering assembly. Still further, the kit 200 includes a clamp 206 that will replace the clamp (such as clamp 124a shown in FIG. 1) removed from the flexible rubber boot on the driver's side when the bushing 202 and clip 204 are installed. The clamp 206 is a simple 2½ inch hose clamp similar to clamps used for radiator hose clamps.

Similar parts may be installed on the passenger side of the steering assembly. However, since the passenger side includes a ball screw, a custom housing or replacement housing may be required on the passenger side in order to accommodate the kit parts on the passenger side.

The bushing 202 is the key component of this kit of parts. In preferred embodiments, the bushing 202 is milled from an acetal Homopolyer, such as Delrin® made by Dupont, a material commonly used in a wide range of products and industries because of its physical properties. For example, Delrin® is used in high-load mechanical applications such as gears, safety restraints, door systems, conveyor belts, health delivery devices and components in many other products.

The reason that preferred embodiments use an acetal homopolyer plastic such as Delrin® for these bushings 202 is that this material is an engineered plastic used in precision parts that require high stiffness, low friction, and excellent dimensional stability and abrasion resistance properties. Other materials, including, for example, metal, other resins, other thermoplastics, or combinations thereof, could also be used to make the bushings 202. However, acetal homopolyer plastic is preferred to avoid metal-to-metal contact.

In an exemplary prototype embodiment of the invention, the bushing 202 has been milled to have outer diameter with a tolerance of approximately one thousandth of an inch (i.e., one mil as an abbreviation for “one milli-inch”) larger than the rack housing that it is intended to be inserted into in order to provide a tight fit into the rack housing. In other words, the outer diameter of the bushing 202 is substantially equal to the inner diameter of the rack housing in order to provide an interference fit between the bushing 202 and the rack housing.

The lumens 208 of the bushings 202 have been milled to have a slight clearance or gap between the inner diameter of the bushing 202 and the outer diameter of the steering rack rod, so that the steering rack rod and rack rod teeth can slide through the lumens 208 of the bushing 202 without contact and/or excessive friction. In other words, the inner diameter of the bushing 202 is only slightly larger than the outer diameter of the steering rack rod so that the rack rod can linearly translate relative to the bushing 202. The gap or clearance between the inner diameter of the bushing 202 and the outer diameter of the rack rod may be about 5-10 mils.

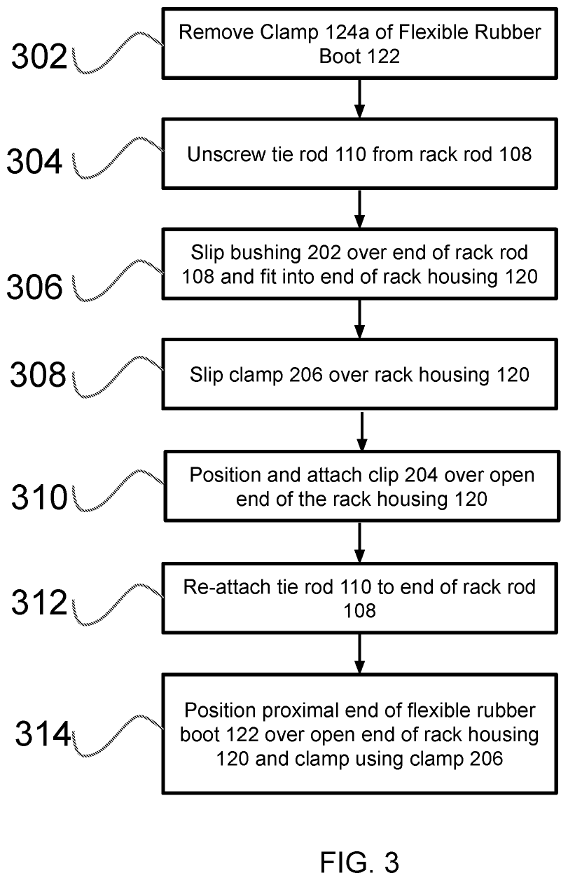

FIG. 3 explains in flowchart format the method 300 for installing the kit of parts 200, using components identified in FIG. 1. In a first step 302, the clamp 124a at the proximal end of the flexible rubber boot 122 is removed so that the boot 122 can be pressed back out of the way. In step 304, the tie rod 110 is unscrewed from the rack rod 108. In step 306, the bushing 202 is slipped over the end of the rack rod 108 and fitted into the rack housing 120. In the exemplary embodiments using 1 mil clearance, the bushing 202 fits tightly into the rack housing 120 without requiring an application of heat. Notably, the bushing 202 is installed without removing the existing plastic bushing 118a.

In step 308, the clamp 206 is slipped over the rack housing 120, to be available to re-clamp the proximal end of the flexible rubber boot 122. In step 310, the clip 204 is positioned and attached over the open end of the rack housing 120 on the driver's side. The purpose of this clip 204 is to ensure that the bushing 202 will remain inside the rack housing 120. That is, although the one mil oversize of the bushing 202 is intended to ensure that the bushing 202 will remain in position inside the end of the rack housing 120, the clip 204 is designed to further ensure that the bushing 202 remains in position inside the end of the rack housing 120.

In step 312, the tie rod 110 is re-attached to the screw end 126 of the rack rod 108. In step 314, the proximal end of the flexible rubber boot is positioned over the open end of the rack housing 120 and clamped using the clamp 206 previously positioned in step 308.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A kit of parts for a rack and pinion steering system modification, the rack and pinion steering system comprising a rack rod disposed inside of a rack housing and a flexible rubber boot removably attached to an open end of the rack housing, wherein the kit comprises:
a bushing comprising an outer diameter and an inner diameter, wherein the bushing is configured to be slid over an end of the rack rod and inserted into the open end of the rack housing on a driver's side;
a clip, to be attached to the open end of the rack housing, to ensure that the bushing remains in position inside the rack housing; and
a hose clamp, to be used to clamp a proximal end of the flexible rubber boot to the open end of the rack housing.

2. The kit of claim 1, wherein the bushing is made of acetal homopolyer.

3. The kit of claim 1, wherein the outer diameter of the hushing is substantially equal to the inner diameter of the rack housing.

4. The kit of claim 3, wherein the outer diameter of the bushing is 1 mil larger than the inner diameter of the rack housing.

5. The kit of claim 1, wherein the inner diameter of the bushing is substantially equal to the outer diameter of the rack rod.

6. The kit of claim 1, wherein the inner diameter of the hushing is at least 5 mils larger than the outer diameter of the rack rod.
